(19) United States
(12) Patent Application Publication
(10) Pub. No.: US 2023/0190039 A1
(43) Pub. Date: Jun. 22, 2023

(54) AIR FRYER

(71) Applicant: Tsann Kuen (Zhangzhou) Enterprise Co., Ltd., Zhangzhou (CN)

(72) Inventors: Yixin ZHAN, Zhangzhou (CN); Bo WEI, Zhangzhou (CN)

(21) Appl. No.: 17/844,550

(22) Filed: Jun. 20, 2022

(30) Foreign Application Priority Data
Dec. 21, 2021 (CN) 202123231957.1

(51) Int. Cl. A47J 37/06; A47J 36/16

(52) U.S. Cl. CPC A47J 37/0641; A47J 36/16

(57) ABSTRACT

The present disclosure provides an air fryer, including a housing, a compartment and a handle. An inserting part of the handle is inserted through a lateral opening of a mounting socket of the compartment, such that the second fixing part is aligned with the first fixing part and fixedly connected with each other through a guide mating of the second guide part and the first guide part to form an internal fixation. It is convenient for consumers to assemble by themselves, and it is firm and non-detachable after assembly, such that not only the volume of the factory packaging can be reduced, but also the safety of use can be ensured.

### CROSS-REFERENCE TO RELATED APPLICATIONS

The present disclosure claims priority to Chinese Patent Application No. 202123231957.1, filed on Dec. 21, 2021, which is incorporated herein by reference in its entirety.

### TECHNICAL FIELD

The present disclosure relates to the field of household appliances, and in particular, to an easy-to-assemble air fryer.

### BACKGROUND

The air fryer is a machine that uses air as a substitute to oil when cooking. The heated air inside extracts moisture from the surface of the food, and thus creating a frying effect. The air fryer comprises a housing with a cooking cavity, a removable cooking compartment, and a handle attached to the cooking compartment. During packaging, the cooking compartment can be inserted into the air fryer to reduce its overall volume, but the exposed handle will increase the width of the package. Therefore, in the prior art, the handle is generally designed to be detachable. However, there are operational flaws to such designs. For instance, users may accidentally press the detach button, and end up damaging the cooking compartment or cause other safety hazards as a result.

### SUMMARY

Therefore, the present disclosure provides an easy-to-assemble air fryer, that comes with a handle in a small package, convenience for home assembly and better safety features.

For achieving the above-mentioned object, the technical solution that the present disclosure provides is as follows.

An air fryer, comprising: a housing with a cooking cavity, a removable cooking compartment used to insert and extract food, and a handle that can be attached to the cooking compartment; wherein: the cooking compartment is provided with a mounting socket at a side wall, the mounting socket having a lateral opening, an inner side wall defining a socket and a bottom wall; the mounting socket is further provided with a first fixing part and a first guide part disposed on the inner side wall of the mounting socket and extending from the lateral opening to the bottom wall; and the handle is provided with an inserting part adapted to the mounting socket, and the inserting part being provided with a second fixing part and a second guide part, the inserting part of the handle is inserted through the lateral opening of the mounting socket and makes the second fixing part align with the first fixing part and fixedly connect with each other through a guide mating of the second guide part and the first guide part.

Further, a plurality of the first guide parts are provided on the inner side wall of the mounting socket and are distributed at intervals; and a plurality of the second guide parts of the inserting part of the handle are provided and correspond to the first guide parts one-to-one.

Further, a guide mating structure of the first guide part and the second guide part is a mating structure of a guide groove and a convex rib, and the convex rib being slidably inserted into the guide groove to achieve guide mating.

Further, the first guide part is the convex rib, and the second guide part is the guide groove.

Further, a fixed mating structure of the first fixing part and the second fixing part is a snap-fit structure of an elastic buckle and a bayonet.

Further, the first fixing part is the bayonet formed on the side wall of the mounting socket, and the second fixing part is the elastic buckle.

Further, the inner side wall of the mounting socket has a guide slope at a front end of the bayonet.

Further, structures of the mounting socket and the inserting part are asymmetric in a circumferential rotation direction.

Further, both of the mounting socket and the inserting part are in a “D” shape.

The technical solution provided by the present disclosure has the following beneficial effects.

The mounting socket on the compartment has only one lateral opening. During assembly, the inserting part of the handle is inserted through the lateral opening of the mounting socket and makes the second guide part align with the first fixing part and fixedly connect with each other through a guide mating of the second guide part and the first guide part, to form an internal fixation. The assembly is simple, and the users can install the handle by themselves. The handle can be packaged separately when leaving the factory, such as being placed in the compartment, such that the volume of the factory package can be reduced. The handle cannot be removed after the fixed assembly, such that the safety of use can be ensured.

### BRIEF DESCRIPTION OF DRAWINGS

FIG. 1 shows a first schematic diagram of a use state of an easy-to-assemble air fryer in the embodiment with the cooking compartment extracted;

FIG. 2 shows a second schematic diagram of the use state of the easy-to-assemble air fryer in the embodiment with the cooking compartment inserted;

FIG. 3 shows the schematic structural diagram of the cooking compartment in the embodiment;

FIG. 4 shows an enlarged diagram of a region A in FIG. 3;

FIG. 5 shows the schematic structural diagram of a handle according to an embodiment;

FIG. 6 is a schematic diagram of an assembly process of the handle and the compartment according to an embodiment;

FIG. 7 is a first schematic structural diagram of the handle and the compartment in an assembled state according to an embodiment;

FIG. 8 shows a second structural schematic diagram of the handle and the compartment in an assembled state according to an embodiment.

### DESCRIPTION OF EMBODIMENTS

To further illustrate the various embodiments, the present disclosure provides accompanying drawings. These drawings are a part of the present disclosure, which are mainly used to illustrate the embodiments, and can be combined with the relevant content of the description to explain the operation principles of the embodiments. With reference to this content, those of ordinary skill in the art should be able to understand the advantages of the present disclosure over prior embodiments. Components in the figures are not drawn to scale, and similar component signs are often used to represent similar components.

The present disclosure will now be further described with reference to the accompanying drawings and specific embodiments.

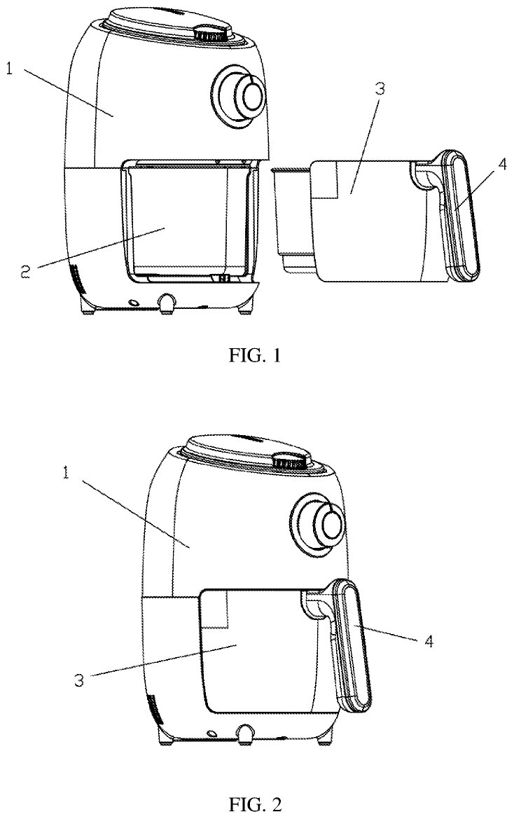

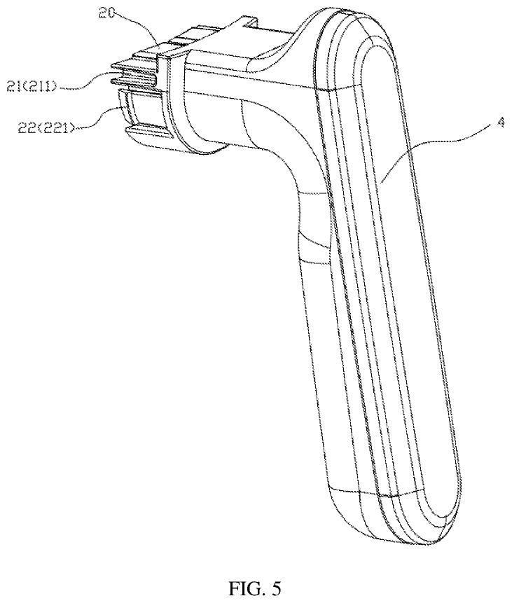

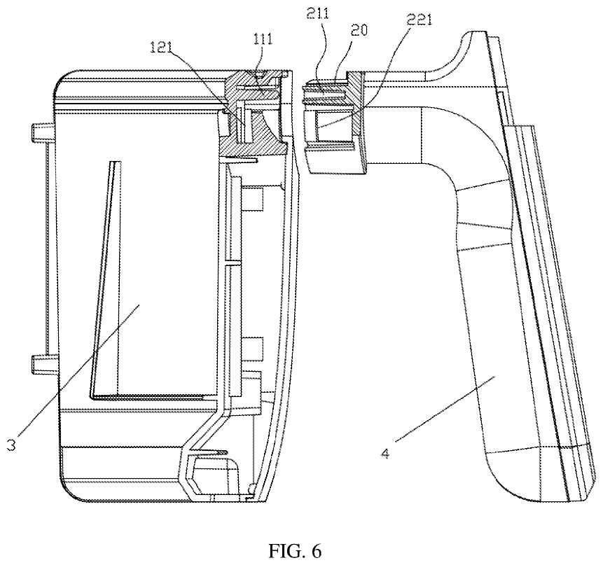

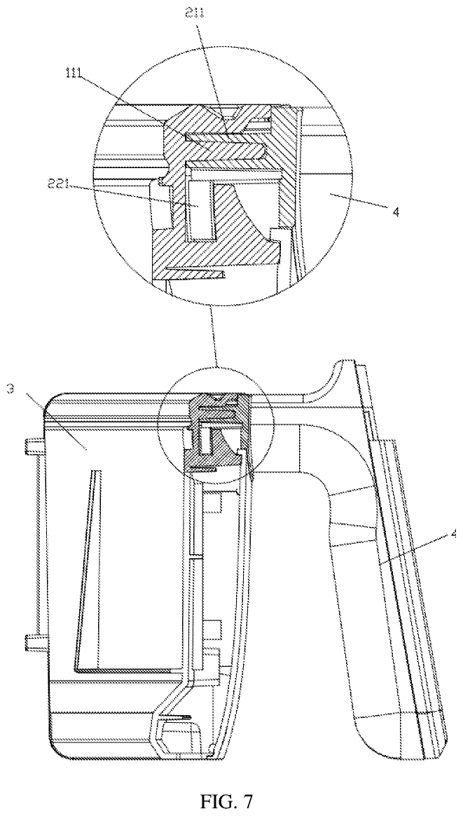

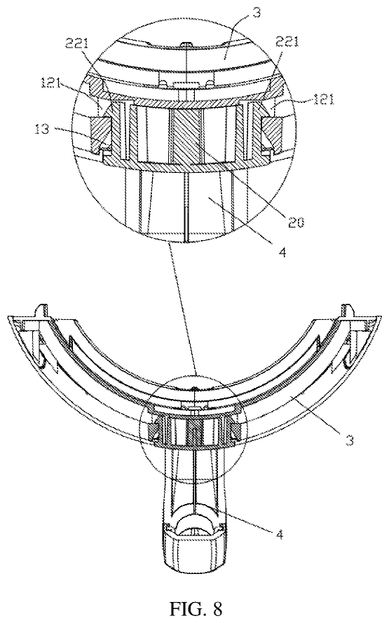

Referring to FIG. 1 to FIG. 8, an easy-to-assemble air fryer provided in the present embodiment includes: a housing 1 with a cooking cavity 2, a cooking compartment 3 that can be inserted into or extracted from the cooking cavity 2, and a handle 4 that can be assembled onto the cooking compartment 3. FIG. 1 shows a state where the cooking compartment 3 is extracted from the cooking cavity 2. FIG. 2 shows a state where the cooking compartment 3 is inserted into the cooking cavity 2.

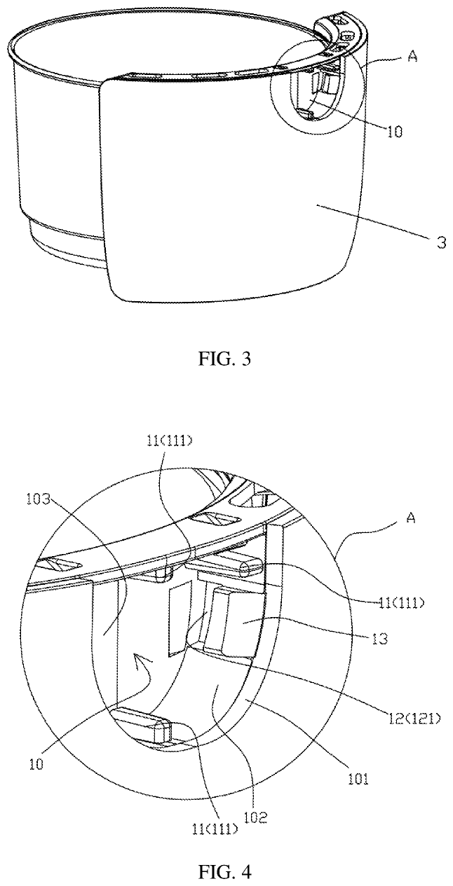

The side wall of the cooking compartment 3 is provided with a mounting socket 10, and the mounting socket 10 has a lateral opening 101, an inner side wall 102 that define a socket and a bottom wall 103. The lateral opening 101 is opposite to the bottom wall 103. The mounting socket 10 is also provided with a first fixing part 12 and a first guide part 11, and the first guide part 11 is formed on the inner side wall 102 of the mounting socket 10 and extends from the lateral opening 101 to the bottom wall 103. The handle 4 is provided with an inserting part 20 adapted to the mounting socket 10. The inserting part 20 is provided with a second fixing part 22 and a second guide part 21. As shown in FIG. 3, to assemble the inserting part 20 of the handle 4 is inserted through the lateral opening 101 of the mounting socket 10. Through the guiding fit of the second guide part 21 and the first guide part 11, the second fixing part 22 is aligned with the first fixing part 12 to achieve lock in. The easy-to-assemble process allows for home assembly. The handle 4 can be packaged independently or placed inside the Air Fryer 3 itself to reduced overall size. The handle cannot be removed once installed, to ensure user safety.

Further, in the present embodiment, the guide mating structure of the first guide part 11 and the second guide part 21 is a mating structure of the guide groove 211 and the convex rib 111, and the convex rib 111 is slidably inserted into the guide groove 211 to achieve a guide mating. Through the sliding and guide mating of the convex rib 111 and the guide groove 211, the present disclosure features a simple structure and good guiding effect, and the structure is easy to realize and can be directly formed by injection molding of a mold.

More specifically, in the present embodiment, the first guide part 11 is the convex rib 111, and the second guide part 21 is the guide groove 211. That is, the convex rib 111 is formed on the inner side wall 102 of the mounting socket 10, and the guide groove 211 is formed on the inserting part 20 of the handle 4. Alternatively, in other embodiments, it is also possible to provide the guide groove 211 on the inner side wall 102 of the mounting socket 10, provide and the convex rib 111 on the inserting part 20 of the handle 4, and so on. Still alternatively, the guide mating structure of the first guide part 11 and the second guide part 21 is implemented in other ways.

Further, in the present embodiment, a plurality of convex ribs 111 are provided on the inner side wall 102 of the mounting socket 10 and are distributed at intervals. Specifically, the number of convex ribs 111 is four, which are respectively distributed in four directions: top, bottom, left, and right. Similarly, there are also four guide grooves 211 on the inserting part 20 of the handle 4, which correspond one-to-one with the convex ribs 111 of the mounting socket 10. In this way, the guiding force is more uniform, making it easier to insert and less likely to be deflected. Alternatively, it is not limited to this in other embodiments.

Further, in the present embodiment, the fixed mating structure of the first fixing part 12 and the second fixing part 22 may be a snap-fit structure of an elastic buckle 221 and a bayonet 121. By adopting the snap fit between the elastic buckle 221 and the bayonet 121, when the inserting part 20 of the handle 4 is inserted in place, automatic fixation can be achieved without additional manual operation, and the assembling operation is simpler and more convenient.

Specifically, the first fixing part 12 is the bayonet 121 formed on the side wall of the mounting socket 10, and the second fixing part 22 is the elastic buckle 221. That is, the bayonet 121 is provided on the side wall of the mounting socket 10, and the elastic buckle 221 is formed on the inserting part 20 of the handle 4. This arrangement is more convenient for preparation. That is to say, a periphery of the inserting part 20 of the handle 4 is not restricted by other structures, and the elastic buckle 221 is formed on the inserting part 20, which is easier to prepare. For example, when integrally formed by injection molding, the elastic buckle 221 is formed on the inserting part 20, which is more convenient for mold release.

Still further, the inner side wall 102 of the mounting socket 10 has a guide slope 13 at the front end of the bayonet 121 (the end close to the lateral opening 101), for guiding the elastic buckle 221. That is, when the inserting part 20 is in an insertion process, the elastic buckle 221 first abuts on the guide slope 13 and deforms, and then the elastic buckle 221 recovers the deformation when the elastic buckle 221 reaches the position of the bayonet 121 and is clamped on the bayonet 121.

Alternatively, in other embodiments, the positions of the bayonet 121 and the elastic buckle 221 can also be interchanged. Still alternatively, the fixed mating structure of the first fixing part 12 and the second fixing part 22 is achieved by adopting other fixing structures.

Further, the structures of the mounting socket 10 and the inserting part 20 is asymmetrical in the circumferential rotation direction. That is, the mounting socket 10 and the inserting part 20 are not rotationally symmetrical structures such as circles, equilateral triangles, and quadrilaterals. Instead, the structures are asymmetric structures in the circumferential rotation direction, so that the operator can more intuitively identify the direction of the handle 4, so as not to install the handle 4 in reverse.

Specifically, in the present embodiment, the mounting socket 10 and the inserting part 20 are both “D”-shaped structures. It is equivalent to cutting a straight section at the upper position on the basis of the circle, thereby forming an asymmetric structure in the circumferential rotation direction. At the same time, the straight section of the side wall above the mounting socket 10 is an upper open end of the cooking compartment 3, which is laid out according to the structure of the cooking compartment 3 itself.

Alternatively, in other embodiments, the shapes of the mounting socket 10 and the inserting part 20 are not limited to this, and the shapes of the mounting socket 10 and the inserting part 20 may also be asymmetrical structures in the circumferential rotation direction, such as trapezoids, and alternatively, the structure may also be symmetrical in the circumferential rotation direction, such as circular or square. However, it is preferable to indicate the installation orientation or set the positions of the first fixing part 12 and the first guide part 11 inside to a non-rotationally symmetrical structure, etc., in order to prevent users from installing the handle 4 incorrectly.

While the present disclosure has been specifically shown and described in connection with preferred embodiments, it will be apparent for those skilled in the art that various changes in form and detail made to the present disclosure without departing from the spirit and scope of the present disclosure as defined by the appended claims are all within the protection scope of the present disclosure.

What is claimed is:

1. An air fryer, comprising: a housing with a cooking cavity, a compartment capable of entering or leaving the cooking cavity, and a handle assembled on the compartment, wherein:
the compartment is provided with a mounting socket at a side wall,
the mounting socket having a lateral opening, an inner side wall defining a socket and a bottom wall,
the mounting socket is further provided with a first fixing part and a first guide part disposed on the inner side wall of the mounting socket and extending from the lateral opening to the bottom wall,
the handle is provided with an inserting part adapted to the mounting socket, the inserting part being provided with a second fixing part and a second guide part, the inserting part of the handle is inserted through the lateral opening of the mounting socket, and the second fixing part is aligned with the first fixing part and fixedly connected with the first guide part through a guide mating of the second guide part and the first guide part.

2. The air fryer according to claim 1, wherein a plurality of the first guide parts are provided on the inner side wall of the mounting socket and are distributed at intervals, and
a plurality of the second guide parts of the inserting part of the handle are provided and correspond to the first guide parts one-to-one.

3. The air fryer according to claim 1, wherein a guide mating structure of the first guide part and the second guide part is a mating structure of a guide groove and a convex rib, the convex rib being slidably inserted into the guide groove to achieve guide mating.

4. The air fryer according to claim 3, wherein the first guide part is the convex rib, and the second guide part is the guide groove.

5. The air fryer according to claim 1, wherein a fixed mating structure of the first fixing part and the second fixing part is a snap-fit structure of an elastic buckle and a bayonet.

6. The air fryer according to claim 5, wherein the first fixing part is the bayonet formed on the side wall of the mounting socket, and the second fixing part is the elastic buckle.

7. The air fryer according to claim 6, wherein the inner side wall of the mounting socket has a guide slope at a front end of the bayonet.

8. The air fryer according to claim 1, wherein structures of the mounting socket and the inserting part are asymmetric in a circumferential rotation direction.

9. The air fryer according to claim 8, wherein both of the mounting socket and the inserting part are in a “D” shape.
